(19) United States
(12) Patent Application Publication
(10) Pub. No.: US 2025/0141008 A1
(43) Pub. Date: May 1, 2025

(54) COMPRESSION DEVICE FOR ACCURATE COMPRESSION LOAD MANAGEMENT IN A BATTERY PACK

(71) Applicant: IEE INTERNATIONAL ELECTRONICS & ENGINEERING S.A., Echternach (LU)

(72) Inventors: Arthur CRETIN, Luxembourg (LU); Patrick DI MARIO COLA, Serrouville (FR); Thierry GONIVA, Luxembourg (LU); Lukas WÜRTH, Arlon (BE)

(21) Appl. No.: 18/835,267

(22) PCT Filed: Feb. 1, 2023
(86) PCT No.: PCT/EP2023/052387

§ 371 Date: Aug. 1, 2024

(30) Foreign Application Priority Data
Feb. 1, 2022 (LU) LU501377

(51) Int. Cl. H01M 50/242; B60L 50/64; H01M 50/211; H01M 50/519

(52) U.S. Cl. CPC H01M 50/242; H01M 50/211; H01M 50/519; B60L 50/64; H01M 2220/20

(57) ABSTRACT

A compression cell for use in a battery pack comprising a plurality of linearly stacked battery cells. The compression cell includes an at least partially fluid-filled and fluid-proof flexible container having at least one inflation channel that provides fluid communication between the flexible container and an exterior of the flexible container.

### TECHNICAL FIELD

The invention relates to a compression cell for use in a battery pack comprising a plurality of linearly stacked battery cells, and to a battery pack comprising a plurality of linearly stacked battery cells and at least one such compression cell.

### BACKGROUND

Modern batteries are used in a wide range of technological fields. For example, batteries are currently used in electrical devices, in vehicles or large-scale industrial facilities. Regularly, several batteries, respectively battery cells, such as e.g. pouch cells, are arranged within a housing of a battery pack.

In view of present mobility-related technologies, such battery packs represent key elements for storing and providing energy for electrical vehicles (EV), hybrid electric vehicles (HEV), plug-in hybrid vehicles (PHEV) and new energy vehicles (NEV).

During its service life, a battery pack is not only exposed to demanding environmental impacts, such as e.g. heat, cold and humidity, but also to demanding reaction dynamics such as, for example, the frequency and number of charging and de-charging processes. These aspects have an influence on the total and remaining service life and condition of the battery pack. As a result, battery cells and battery packs are subject to aging and degradation processes, which may increase the occurrence of “swelling” or “gassing”.

“Gassing” may generally refer to a phenomenon caused by gas generation inside a battery (cell). Gassing may result from the decomposition of the electrolyte inside the battery and/or be caused by overheating and/or overcharging a battery. A gassing battery cell may swell, break or even explode. “Swelling” generally refers to a volume change of the battery (cell). The swelling may for example be caused by storage and removal processes of lithium ions in and/or on the electrode. Swelling may also be caused by gassing. Swelling leads to a mechanical deformation of the battery cell, which causes pressure forces in and/or on the enclosure of the battery cell and/or the battery pack. In order to compensate swelling, battery manufacturers usually use rigid structures such as metal or hard plastic housings which counter expansions of the housing. Furthermore, the battery manufacturers typically include elastic materials, such as foams, in the stack to absorb the swelling.

An expansion, respectively a displacement or dilatation caused by the occurrence of pressure forces during swelling, may correlate with the so-called “State of Health” (SOH) of a battery pack. “State of health” generally refers to the aging state of a battery pack, which thus represents a measure, respectively an indicator, of the battery pack ability to store and deliver electrical energy in comparison to a new battery pack. The dilatation is also used to determine and/or predict the end of life (EOL) of the battery pack. The EOL generally is used to determine a period in which the battery pack may be safely charged and discharged. The EOL may also be used, like the SOH, as an indicator for indicating the remaining operating time, respectively the remaining service life time, of the battery pack.

In order to enhance the security and reliability of the battery pack in its operation environment, a battery management system (BMS) is often used to determine or estimate the state of charge (SOC) of the respective battery cells of the battery pack as well as the SOH and the EOL. The “state of charge” generally refers to the available capacity which might be expressed or represented as a percentage of its predetermined capacity. In other words, SOC, EOL and SOH are indicators that are determinable by the BMS.

It is further possible to configure the BMS to measure and/or determine further parameters of the battery pack and/or the battery cells, such as e.g. the temperature values and/or the voltages of battery cells. The BMS may have also access to pre-determined and stored specific battery cell characteristic data and measurements, taken from a reference battery cell and/or a reference battery pack. Based on such data, the BMS may, for example, compare stored and/or measured values of a cell with the reference values in order to more precisely determine the different indicators. The BMS may further be configured to monitor the functioning of the respective cells as well as the charging and discharging processes. As a result, the BMS may identify defective cells and switch off such cells. In most cases, the cells have to be replaced when they have been identified as defective; typically, the entire module or pack is replaced.

The useful life, respectively the service life time or remaining operating time, of the battery may be limited by a maximum pressure applied on the mechanical enclosure, respectively the housing, of the battery pack. Usually, the value of the maximum bearable pressure is known by manufacturers. A pressure (force) exceeding the predetermined maximum bearable pressure may lead to a failure of the battery cell, the housing or the entire battery pack. For example, a pressure which is caused by a swelling of a battery cell and which exceeds the predetermined maximum bearable pressure value may result in a breach of the battery cell. For this reason, battery management systems may also be configured to detect swellings.

In order to detect a swelling, common battery management systems use algorithms or complex mechanical devices to perform estimations on the current condition, respectively state, of the battery cell and/or the battery pack. The use of such algorithms may be based or rely on more or less correct estimation(s) of the EOL indicator, the SOC indicator or the SOH indicator. Alternatively, in order to determine a state of the battery, the BMS can be subjected to test conditions within a laboratory or a test bench, for example. In this context, the battery pack is examined by means of or connected to complex mechanical measurement devices.

For example, US 2014/0107949 A1 describes a battery management system for use with a battery under test conditions. The system includes a container configured to hold the battery. The system also includes a stress/strain sensor. The container is configured to hold the battery in fixed relationship with respect to the stress/strain sensor. A processor is coupled to the stress/strain sensor, wherein the processor is configured to measure the stress/strain on the battery and determine the state of health (SOH) of the battery based on the measured stress/strain and previously stored SOH relationship data for the battery. The processor may be configured to determine a state of charge (SOC) of the battery based on the measured stress/strain, the SOH of the battery and previously stored SOC relationship data for the battery.

Further, DE 10 2012 209 271 A1 describes at least one battery cell with a cell housing and an electrode winding arranged inside the cell housing. The battery management system includes a battery condition detection. The electrode winding of the battery cell is at least partially covered by a pressure-sensitive film sensor. The battery state detection mechanism is designed to read in a measured value provided by the pressure-sensitive film sensor, or a variable derived from this measured value, and to use the measured value or variable as an evaluation parameter for determining the battery state. The battery state detection mechanism is configured to determine a swelling force from the swelling of the electrode winding due to the state of charge of the same, using the measured value provided by the pressure-sensitive film sensor or the derived variable. The swelling force is used for further determining the state of charge (SOC) or state of health (SOH) of the battery cell.

In battery packs with linearly stacked battery cells it is known in the art to use one or more compression pads stacked between adjacent battery cells to ensure a slight compression in a newly built condition, and further to allow for expansion and contraction during charging, discharging and aging. Typical values to be covered by the compression pads are a few % of the battery pack length over the battery pack lifetime. For the material used in such compression pads, a stress-strain curve showing a low compressive stress across a broad range of compressive strain is desirable. Further, the material should show an as low as possible compression set particularly at conditions of high relative humidity and temperatures in an upper region of the regular operating range of the battery pack. A known example for such a material is micro-cellular polyurethane foam.

Due to mechanical tolerances of battery pack components such as enclosure, cells, which usually are used in a large number so that even low tolerances of cells add up and become noticeable, and (compensation) foam pads, and due to the expansion and contraction, respectively, during charging, discharging and aging of the battery pack, it is a demanding task to ensure a desired predefined compression load within the battery pack at all the different conditions. Conventionally, this can be accounted for by employing foam pads in a portion of the battery pack sufficiently large to compensate for an estimated swelling over the battery pack lifetime. Obviously, this results in compromising the battery pack power density.

### SUMMARY

It is therefore an object of the invention to provide a compression device for use in a battery pack comprising a plurality of linearly stacked battery cells, in particular pouch cells, with the compression device ensuring a desired predefined compression load within the battery pack during assembly and during a maximum number of different operating conditions that potentially occur during the lifetime of the battery pack.

In one aspect of the present invention, the object may be achieved by a battery pack comprising a plurality of linearly stacked battery cells and a compression cell. The compression cell comprises an at least partially fluid-filled and fluid-proof flexible container having at least one inflation channel that provides fluid communication between the flexible container and an exterior of the flexible container. The term “fluid-proof container”, as used in the present patent application, shall particularly be understood such that the container is fluid-tight except for deliberately arranged fluid communication paths.

The proposed compression cell provides all the prerequisites for enabling passive or active, in particular dynamic, accurate compression load management in a battery pack by employing an appropriate embodiment. The accurate compression load management can be achieved in spite of mechanical tolerances of battery pack components. In battery packs with a large swelling ratio of the battery cells, the proposed compression cell can accomplish ensuring a desired predefined compression load within the battery pack with virtually no reduction in power density.

The fluid may be a gas, for example air, or a gel. Another portion of the volume of the at least partially fluid-filled flexible container may be taken by a foam, for instance a micro-cellular polyurethane foam.

The compression cell is in particular advantageously employable in battery packs for automotive applications. The term “automotive”, as used in the present patent application, shall particularly be understood as being suitable for use in vehicles including passenger cars, trucks, semi-trailer trucks and buses.

It is further conceived that the proposed compression cell or compression cells can be used in addition to compression pads employed in conventional battery packs, as well as in replacement of such compression pads.

In preferred embodiments of the compression cell, the at least one inflation channel is at least convertible from an open state to a sealed state, and provides fluid communication between the flexible container and an exterior of the flexible container in the open state and blocks the fluid communication in the sealed state.

By that, the option can be provided to inflate and pressurize the compression cell during assembly of the battery pack to achieve a desired compression load within the battery pack, and then to permanently seal off the at least one inflation channel, which can allow to set the desired compression load within the battery pack to the stacked battery cells to a specific value even in case of large mechanical tolerances of battery pack components such as enclosure, cells, and (compensation) foam pads.

Preferably in such embodiments, the compression cell further includes at least one pressure-sensitive member, comprising a plurality of electric pins, that is arranged within the flexible container, a plurality of electric feedthroughs providing electric connections from an inside of the flexible container to the exterior of the flexible container, and a plurality of electric lines that electrically connect the plurality of electric feedthroughs and the plurality of electric pins.

In this way, valuable information can be provided regarding a rise of the compression load within the battery pack. As a rising compression load is one of the first symptoms of an upcoming thermal runaway of the battery pack, the proposed compression cell can, with an especially compact design, further enable an early detection of an occurrence of thermal runaway, and can support in taking measures for potential prevention by precise sensing of a current compression load. Further, the proposed compression cell provides the prerequisites for continuous monitoring of the compression load within the battery pack and thus can support in evaluating the state of health of the battery cells by applying one of well-known suitable evaluation methods.

Thermal runaway is known to be one of the most serious failure modes of a rechargeable traction battery. Details are, for instance, described in Koch, Sascha et al. “Fast Thermal Runaway Detection for Lithium-Ion Cells in Large Scale Traction Batteries.” (Batteries 2018, 4(2), 16; DOI: 10.3390/batteries4020016). Thermal runaway of single cells within a large-scale lithium-ion battery pack is a well-known risk that can lead to critical situations if no counter measures are taken in today's lithium-ion traction batteries for battery electric vehicles (BEVs), plug-in hybrid electric vehicles (PHEV) and hybrid electric vehicles (HEVs). Fast and reliable detection of faulty cells undergoing thermal runaway within the lithium-ion battery is therefore a key factor in battery designs for comprehensive passenger safety.

In preferred embodiments of the compression cell, which contain at least one pressure-sensitive element in the manner proposed above, the at least one inflation channel is configured to be fluid-technically connectable with an outside-facing end to an on-board release valve. This can allow to set the desired compression load within the battery pack to the stacked battery cells to a specific value even in case of large mechanical tolerances of battery pack components such as enclosure, cells, and (compensation) foam pads, and to maintain the set desired compression load even in case of significant swelling of the battery cells of the battery pack.

The phrase “being configured to”, as used in this application, shall in particular be understood as being specifically laid out, furnished or arranged. The term “release valve”, as used in the present application, shall particularly be understood as a valve that is configured to be in a closed state below a predefined threshold value for the pressure, and to maintain the predefined threshold pressure level at the high pressure side.

In such embodiments of the compression cell it is further preferred that the at least one inflation channel is configured to provide a fluid-technical connection from an upstream-arranged on-board fluid pressure device to the flexible container via the on-board release valve. This can allow, besides a limitation of the compression load, also for an increase in the compression load, and thus can enable especially flexible options for an accurate compression load management in the battery pack.

In preferred embodiments, the compression cell includes at least one fluid-proof pressure chamber that is arranged inside the flexible container. The compression cell is further equipped with at least one deflation device for each pressure chamber, wherein the deflation device includes at least one deflation channel and at least one release valve. The deflation device is configured for providing a fluid-technically connection between an inside of the respective pressure chamber and the exterior of the flexible container when a pressure inside the respective pressure chamber exceeds a predefined pressure level.

In case of an increasing swelling of the battery cells in the battery pack, the compression load within the battery pack is limited to the predefined pressure level, as each pressure chamber releases some of its contents to the exterior of the flexible container, to allow for an expansion of the battery cells without an increase in pressure.

Preferably in such embodiments, the compression cell further includes at least one pressure-sensitive member, comprising a plurality of electric pins, that is arranged within the flexible container and outside of the pressure chamber or outside of each of the pressure chambers, a plurality of electric feedthroughs providing electric connections from an inside of the flexible container to the exterior of the flexible container, and a plurality of electric lines that electrically connect the plurality of electric feedthroughs and the plurality of electric pins.

In this way, valuable information can be provided regarding a rise of the compression load within the battery pack, which can be exploited for early detection of an upcoming thermal runaway of the battery pack, as explained before.

In preferred embodiments of the compression cell, dimensions of the flexible container in a virtual plane transverse to a stacking direction of the battery pack are adapted to respective dimensions of the battery cells. In this way, a major portion of the cross-sectional area of the battery pack can be used so as to provide the compression load in a most even manner.

Preferably, embodiments of the compression cell of the described kind include a dielectric carrier member which is arranged within the flexible container, and which at least the electric lines of the plurality of electric lines are fixedly attached to. By that, a compact and mechanically stable solution can be provided for the electric lines of the compression cell, which can result in a high degree of operational reliability.

In preferred embodiments of the compression cell, the dielectric carrier member is made for the most part from a planar foil of plastic material that is selected from a group of plastic materials formed by polyethylene terephthalate (PET), polyimide (PI), polyetherimide (PEI), polyethylene naphthalate (PEN), polyoxymethylene (POM), polyamide (PA), polyphthalamide (PPA), polyether ether ketone (PEEK), and combinations of at least two of these plastic materials, and the electric lines of the plurality of electric lines comprise cured electrically conductive ink.

The term “for the most part”, as used in the present application, shall particularly be understood as equal to or more than 70%, more preferably more than 80%, and, most preferably, more than 90% in volume, and shall encompass a part of 100%, i.e. the dielectric carrier member is completely made from the selected plastic material.

These plastic materials can allow for easy manufacturing, and durable, cost-efficient dielectric carrier members of low manufacturing tolerances can be provided in this way. The use of a planar foil of plastic material can allow for an assembly with an especially compact design in particular in a direction perpendicular to the surface of dielectric carrier member.

By making the electric lines of the plurality of electric lines from electrically conductive ink, an application of high-precision manufacturing methods such as screen printing and ink jet printing is facilitated, resulting in low production tolerances and little material waste.

In preferred embodiments of the compression cell, the dielectric carrier member is made for the most part from glass-reinforced epoxy laminate material, and the electric lines of the plurality of electric lines are formed by etched copper tracks. In this way, a dielectric carrier member of low weight and high mechanical stability can be provided and can be made using the well-known methods for producing printed circuit boards.

In at least some embodiments, the flexible container of the compression cell is arranged in the battery pack in mechanical contact to at least one battery cell. The benefits described in context with the compression cell apply to the proposed battery pack to the full extent.

In particular, the battery cells of the battery pack may be designed as pouch cells, as is known in the art.

In preferred embodiments, the battery pack further includes an on-board release valve and an on-board fluid pressure device, wherein the at least one inflation channel is fluid-technically connected with an outside-facing end to the on-board release valve and, in at least one operating state, provides a fluid-technical connection from the on-board fluid pressure device that is arranged upstream, to the flexible container via the on-board release valve.

These and other aspects of the invention will be apparent from and elucidated with reference to the embodiments described hereinafter.

It shall be pointed out that the features and measures detailed individually in the preceding description can be combined with one another in any technically meaningful manner and show further embodiments of the invention. The description characterizes and specifies these embodiments in particular in connection with the figures.

### BRIEF DESCRIPTION OF THE DRAWINGS

Further details and advantages of the present invention will be apparent from the following detailed description of not limiting embodiments with reference to the attached drawing, wherein:

FIG. 1 schematically shows an embodiment of a battery pack in accordance with the invention, installed in a battery electric vehicle, in a perspective partial ghosted illustration,

FIG. 2 is a schematic perspective partial view on one of the battery packs pursuant to FIG. 1, including an explosion view of an embodiment of a compression cell in accordance with the invention stacked between battery cells of the battery pack,

FIG. 3 is a schematic illustration of the compression cell pursuant to FIG. 2, in a side sectional view,

FIG. 4 is a schematic illustration of the compression cell pursuant to FIG. 2 in a front sectional view as seen in the stacking direction,

FIG. 5 is a schematic illustration of a further development of the compression cell pursuant to FIG. 4 in a front sectional view as seen in the stacking direction, and

FIG. 6 is a schematic illustration of an alternative embodiment of the compression cell in accordance with the invention in a front sectional view as seen in the stacking direction.

In the different figures, the same parts are always provided with the same reference symbols or numerals, respectively. Thus, they are usually only described once.

### DETAILED DESCRIPTION

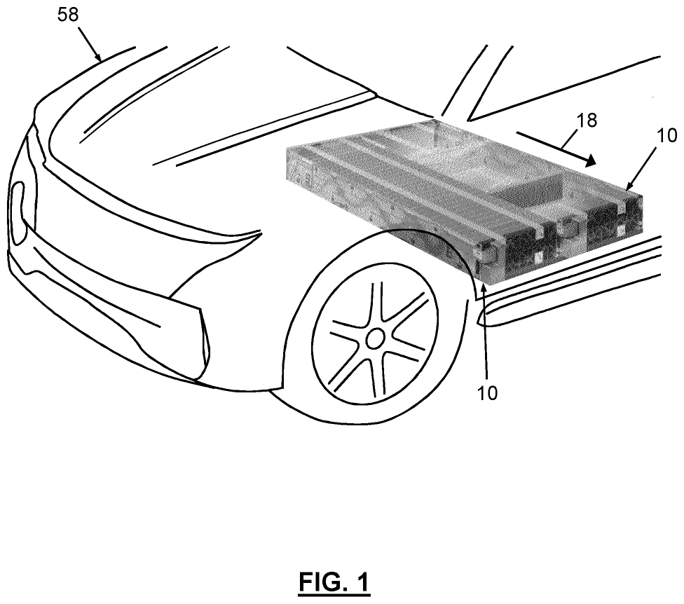

FIG. 1 schematically shows a plurality of an embodiment of battery packs 10 in accordance with the invention, installed in a battery electric vehicle 58, in a perspective partial ghosted illustration. In this specific embodiment, the vehicle 58 may be designed as a passenger car, but in other embodiments the plurality of battery packs 10 may be installed in a truck or a bus.

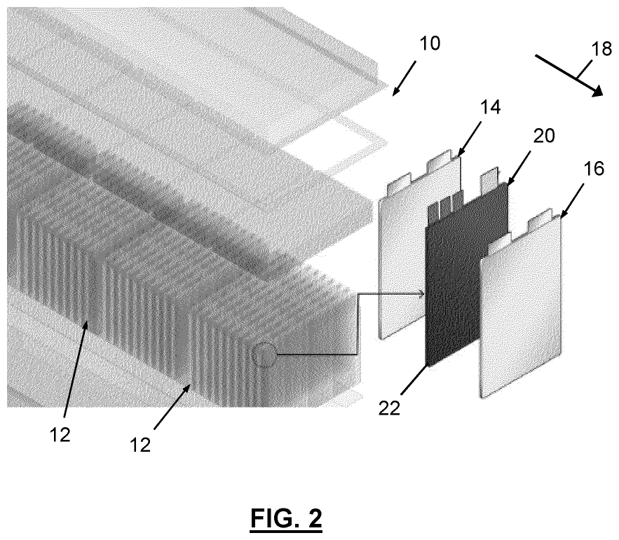

FIG. 2 is a schematic perspective partial view on one of the battery packs 10 pursuant to FIG. 1, which is shown exemplarily for all of the battery packs 10. The battery pack 10 comprises a plurality of battery cells 12, 14, 16, which are linearly stacked in a stacking direction 18, and which in particular may be formed by pouch cells. In this specific embodiment, the stacking direction 18 is arranged parallel to the width direction of the vehicle 58.

The battery pack 10 further comprises a plurality of compression cells 20. An embodiment of one of the compression cells 20 for use in the battery pack 10 is exemplarily shown in FIG. 2 in an explosion view. The compression cell 20 is stacked between two battery cells 14, 16 of the battery pack 10.

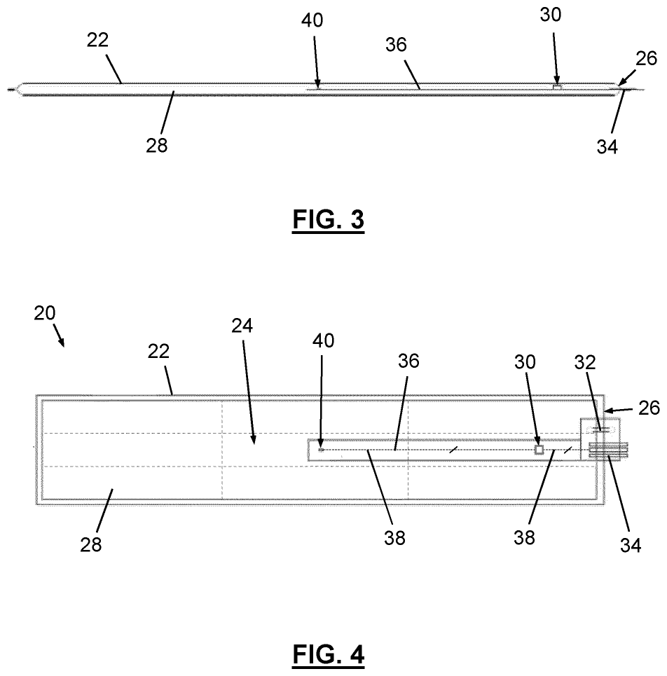

FIG. 3 is a schematic illustration of the compression cell 20 pursuant to FIG. 2 in a sectional side view. FIG. 4 is a schematic illustration of the compression cell 20 pursuant to FIG. 2 in a sectional front view as seen in the stacking direction 18.

The compression cell 20 comprises a fluid-proof flexible container 22 that is substantially formed as a hollow rectangular block. An example of an appropriate material for the flexible container 22 is a sandwich laminate comprising aluminum and polyethylene (PE) and/or polypropylene (PP). As indicated in FIG. 2, dimensions of the flexible container 22 in a virtual plane transverse to the stacking direction 18 of the battery pack 10 are adapted to respective dimensions of the battery cells 12, 14, 16. Depending on the specific purpose, the flexible container 22 may be partially filled by a fluid 28 (FIG. 4) such as a gas, for example air, or a gel. Another portion of the volume of the flexible container 22 may be taken by a foam, for instance a micro-cellular polyurethane foam.

The compression cell 20 has an inflation channel 32 that provides fluid communication between the flexible container 22 and an exterior of the flexible container 22. More specifically, the inflation channel 32 is convertible from an open state to a sealed state, and provides fluid communication between the flexible container 22 and an exterior of the flexible container 22 in the open state, and blocks the fluid communication in the sealed state. The inflation channel 32 may be made from metal, and may be convertible from the open state to the sealed state by welding or soldering or by applying an appropriate pinch-off technique or a combination of these techniques.

The compression cell 20 further includes a pressure-sensitive member 30, which comprises a plurality of electric pins (not shown). The pressure-sensitive member 30 may be formed by an IC-based capacitive sensor device with micro-machined features. Such sensors are commercially available these days. They are particularly configured for automotive applications, and are well known in the art. Some of these sensors convert an absolute pressure into an analog output signal provided at its plurality of electric pins. The pressure-sensitive member 30 is arranged within the flexible container 22. Due to the fluid-filling of the flexible container 22, any force exerted on the flexible container 22 from the outside is transmitted to the pressure-sensitive member 30.

The fluid-proof flexible container 22 is equipped with a plurality of electric feedthroughs 34, which are located at a container side 26 (FIG. 4), and which provide electric connections from an inside of the flexible container 22 to the exterior of the flexible container 22. The compression cell 20 further comprises a dielectric carrier member 36 and a plurality of electric lines 38.

In this specific embodiment (FIGS. 3 and 4), the dielectric carrier member 36 is made for the most part from a planar foil of plastic material, for instance polyimide (PI), which may have a thickness of about 50 μm to provide mechanical strength as well as sufficient flexibility. The electric lines 38 of the plurality of electric lines 38 of the compression cell 20 are fixedly attached to the dielectric carrier member 36, and may be produced by dispensing electrically conductive ink, for instance by screen printing or ink jet printing, onto the dielectric carrier member 36 and then applying a curing procedure.

In alternative embodiments (not shown) for applications with different requirements, the dielectric carrier member 36 may be made for the most part from glass-reinforced epoxy laminate material, and the electric lines 38 of the plurality of electric lines 38 may be formed by etched copper tracks.

The pressure-sensitive member 30 is fixedly attached to the dielectric carrier member 36 by connecting the electric pins to the plurality of electric lines 38, for instance by soldering. In addition, an adhesive may be applied to attach the pressure-sensitive member 30 to the dielectric carrier member 36. At an end facing away from the pressure-sensitive member 30, the electric lines 38 of the plurality of electric lines 38 are electrically connected to the plurality of electric feedthroughs 34.

With reference to FIG. 2, the compression cell 20 is stacked between the two battery cells 14, 16 of the battery pack 10 such that the flexible container 22 is arranged in mechanical contact to both the battery cells 14, 16. An ultimate tensile strength of the material of the flexible container 22 of the compression cell 20 may exceed an ultimate tensile strength of the pouch material of the battery cells 12, 14, 16, for instance by choosing a larger material thickness.

The dielectric carrier member 36 extends from the container side 26 into a center region 24 of the flexible container 22, which is indicated by dashed lines in FIG. 4. The compression cell 20 is further equipped with a temperature sensor 40, which for instance may be formed by an NTC (negative temperature coefficient) temperature sensor. The temperature sensor 40 is fixedly attached to an end of the dielectric carrier member 36 that faces away from the electric feedthroughs 34. Electric contacts of the temperature sensor 40 are electrically connected to feedthroughs 34 of the plurality of electric feedthroughs 34 by electric lines 38 of the plurality of electric lines 38.

The temperature sensor 40 is thus arranged within the flexible container 22, and, more specific, is arranged in the center region 24 of the flexible container 22, which can be defined by a middle third with respect to the dimensions of the flexible container 22 in a virtual plane perpendicular to the stacking direction 18, so as to capture a temperature that can be considered a characteristic battery pack temperature. In FIG. 4, the virtual plane coincides with the drawing plane.

The compression cell 20 pursuant to FIGS. 3 and 4 is configured to be inserted in the battery pack, for instance stacked between the two battery cells 14, 16 of the battery pack 10, during assembly at ambient pressure conditions. After complete assembly of the battery pack 10 the compression cell 20 can be pressurized to the desired compression load for generating a mechanical pre-load on the battery cells. When the desired compression load is reached, the inflation channel 32 can be converted from the open state to the sealed state, for instance by combined pinch-off and welding. This allows to set the desired compression load on the stacked battery cells to a specific value even in case of large mechanical tolerances of enclosure, cell and/or (compensation) foam pads. Thus, in the embodiment pursuant to FIGS. 3 and 4, the compression cell 20 serves as an active pressure adjustment means.

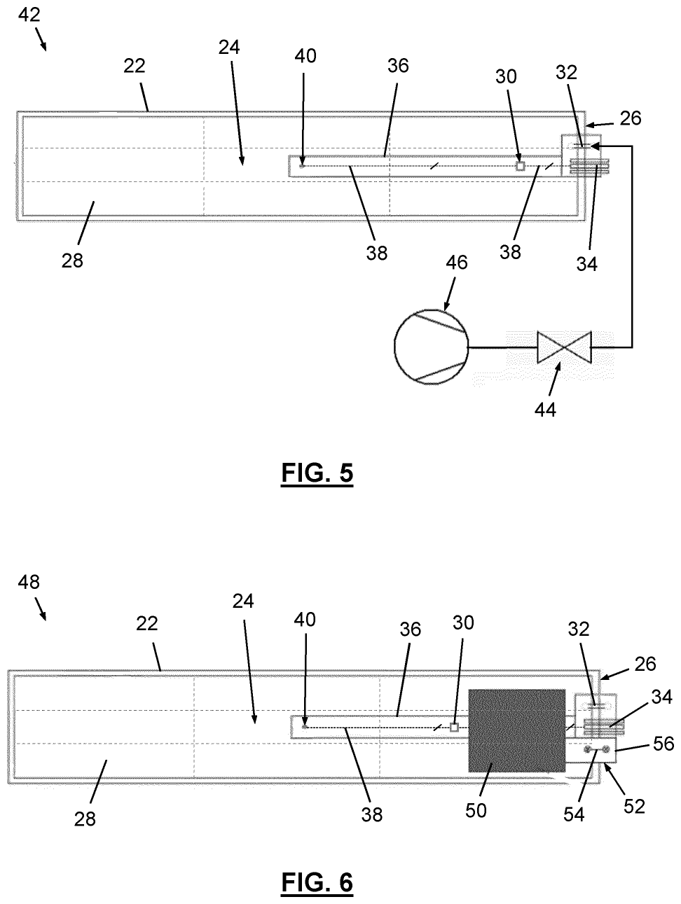

FIG. 5 is a schematic illustration of a further development of the compression cell 42 pursuant to FIG. 4 in a front sectional view as seen in the stacking direction 18. In order to avoid unnecessary repetitions, only differences with respect to the first embodiment will be described. For features that are not described, reference is made to the description of the first embodiment.

In the compression cell 42 pursuant to FIG. 5, the inflation channel 32 is configured to be fluid-technically connectable with an outside-facing end to an on-board release valve 44. This release valve 44, in turn, is connected to an upstream-arranged on-board fluid pressure device 46, which may be formed by a compressor or a pump, respectively.

The compression cell 42 pursuant to FIG. 5 is configured to be inserted in the battery pack 10, for instance stacked between the two battery cells 14, 16 of the battery pack 10, during assembly at ambient pressure conditions. After complete assembly of the battery pack 10, the compression cell 42 can be pressurized to the desired compression load for generating a mechanical pre-load on the stacked battery cells, and the desired compression load can actively be maintained throughout the lifetime of the battery pack. In the embodiment pursuant to FIG. 5, the compression cell 42 serves as an active pressure control means.

For instance, a (partial) deflation of the flexible container 22 can be carried out by releasing pressure via the release valve 44 if so required, based on information that may be provided by an on-board battery pack pressure sensing system (not shown).

Also, the flexible container 22 can be inflated or the pressure within the flexible container 22 can be increased by connecting the flexible container 22 of the compression cell 42 to the on-board fluid pressure device 46 and a valve, and by controlling the action of these devices, employing the on-board battery pack pressure sensing system.

FIG. 6 is a schematic illustration of an alternative embodiment of the compression cell 48, in a front sectional view as seen in the stacking direction 18.

In comparison to the embodiments of the compression cell 22, 42 pursuant to FIGS. 3, 4 and 5, the compression cell 48 pursuant to FIG. 6 further includes a fluid-proof pressure chamber 50 that is arranged inside the flexible container 22. The pressure-sensitive member 30 is arranged within the flexible container 22 and outside of the pressure chamber 50. Moreover, the compression cell 48 is equipped with a deflation device 52 for the pressure chamber 50. The deflation device 52 includes a deflation channel 54 and a release valve 56. The deflation device 52 is configured for providing a fluid-technically connection between an inside of the pressure chamber 50 and the exterior of the flexible container 22 when a pressure inside the pressure chamber 50 exceeds a predefined pressure level.

The compression cell 48 pursuant to FIG. 6 is configured to be inserted in the battery pack 10, for instance stacked between the two battery cells 14, 16 of the battery pack 10, during assembly at ambient pressure conditions. After complete assembly of the battery pack 10 the compression cell 48 can be pressurized to the desired compression load for generating a mechanical pre-load on the stacked battery cells. By passive control, the release valve 56 and the pressure chamber 50 will ensure that the compression load will be maintained at the desired compression load throughout the lifetime of the battery pack 10. Thus, in the embodiment pursuant to FIG. 6 the compression cell 48 serves as a passive pressure control means.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. A battery pack comprising a plurality of linearly stacked battery cells and at least one compression cell, wherein said at least one compression cell comprises an at least partially fluid-filled and fluid-proof flexible container having at least one inflation channel that provides fluid communication between the flexible container and an exterior of the flexible container.

2. The battery pack as claimed in claim 1, wherein the at least one inflation channel is at least convertible from an open state to a sealed state, and provides fluid communication between the flexible container and an exterior of the flexible container in the open state and blocks the fluid communication in the sealed state.

3. The battery pack as claimed in claim 2, wherein the at least one compression cell comprises:
at least one pressure-sensitive member, comprising a plurality of electric pins, that is arranged within the flexible container,
a plurality of electric feedthroughs providing electric connections from an inside of the flexible container to the exterior of the flexible container, and
a plurality of electric lines that electrically connect the plurality of electric feedthroughs and the plurality of electric pins.

4. The battery pack as claimed in claim 1, wherein at least one compression cell comprises:
at least one pressure-sensitive member, comprising a plurality of electric pins, that is arranged within the flexible container,
a plurality of electric feedthroughs providing electric connections from an inside of the flexible container to the exterior of the flexible container, and
a plurality of electric lines that electrically connect the plurality of electric feedthroughs and the plurality of electric pins, wherein the at least one inflation channel is configured to be fluid-technically connectable with an outside-facing end to an on-board release valve.

5. The battery pack as claimed in claim 4, wherein the at least one inflation channel is configured to provide a fluid-technical connection from an upstream-arranged on-board fluid pressure device to the flexible container via the on-board release valve.

6. The battery pack as claimed in claim 1, wherein at least one compression cell comprises:
at least one fluid-proof pressure chamber that is arranged inside the flexible container, and
at least one deflation device for each pressure chamber, wherein the deflation device includes at least one deflation channel and at least one release valve and is configured for providing a fluid-technically connection between an inside of the respective pressure chamber and the exterior of the flexible container when a pressure inside the respective pressure chamber exceeds a predefined pressure level.

7. The battery pack as claimed in claim 6, wherein the at least one compression cell comprises:
at least one pressure-sensitive member, comprising a plurality of electric pins, that is arranged within the flexible container and outside of the pressure chamber or outside of each of the pressure chambers,
a plurality of electric feedthroughs providing electric connections from an inside of the flexible container to the exterior of the flexible container, and
a plurality of electric lines that electrically connect the plurality of electric feedthroughs (34) and the plurality of electric pins.

8. The battery pack as claimed in claim 1, wherein at least one compression cell is characterized in that dimensions of the flexible container in a virtual plane transverse to a stacking direction of the battery pack are adapted to respective dimensions of the battery cells.

9. The battery pack as claimed in claim 3, wherein at least one compression cell is characterized by a dielectric carrier member which is arranged within the flexible container, and which at least the electric lines of the plurality of electric lines are fixedly attached to.

10. The battery pack as claimed in claim 9, wherein:
the dielectric carrier member is at least partially made from a planar foil of plastic material that is selected from a group of plastic materials formed by polyethylene terephthalate PET, polyimide PI, polyetherimide PEI, polyethylene naphthalate PEN, polyoxymethylene POM, polyamide PA, polyphthalamide PPA, polyether ether ketone PEEK, and combinations of at least two of these plastic materials, and
the electric lines of the plurality of electric lines comprise cured electrically conductive ink.

11. The battery pack as claimed in claim 9, wherein the dielectric carrier member is made for the most part from glass-reinforced epoxy laminate material, and the electric lines of the plurality of electric lines are formed by etched copper tracks.

12. The battery pack as claimed in claim 1, wherein the flexible container of at least one compression cell is arranged in mechanical contact to at least one battery cell.

13. The battery pack as claimed in further comprising an on-board release valve and an on-board fluid pressure device, wherein the at least one inflation channel is fluid-technically connected with an outside-facing end to the on-board release valve and, in at least one operating state, provides a fluid-technical connection from the on-board fluid pressure device that is arranged upstream, to the flexible container via the on-board release valve.
